(19) United States
(12) Patent Application Publication
(10) Pub. No.: US 2002/0030347 A1
(43) Pub. Date: Mar. 14, 2002

(54) Self hitch vehicle positioning system

(76) Inventor: Nick Korneff, Montebello, CA (US)

Correspondence Address: Jack I. J'maev, 12616 Lewis Ave, Chino, CA, 91710, US

(21) Appl. No.: 09/952,124

(22) Filed: Sep. 11, 2001

Related U.S. Application Data
(60) Provisional application No. 60/232,233, filed on Sep. 12, 2000.

(51) Int. Cl. B60D 1/00

(52) U.S. Cl. 280/479.2; 280/479.3

(57) ABSTRACT

A system for allowing a single user to accurately gauge the distance between a trailer connecting mechanism and a trailer ball of a trailer hitch and which provides a mechanism for indicating when the trailer ball is positioned beneath the trailer attachment end that includes a user adjustable center mechanism of a U-shaped mechanism that has a pair of spaced outwardly extending elements such that when the user backs over one of the outstretched spaced elements the trailer ball is positioned beneath the trailer attachment end of the trailer.

### RELATED APPLICATIONS

This present application is related to a provisional application Ser. No. 60/232,233 filed on Sep. 12, 2000, entitled “SELF HITCH VEHICLE POSITIONING SYSTEM”, by Nick Korneff, currently pending, for which the priority date for this application is hereby claimed.

### FIELD OF THE INVENTION

This invention relates generally to vehicular trailer accessories; and specifically to a device for guiding a tow vehicle toward a trailer for attachment.

### BACKGROUND OF THE INVENTION

It is often difficult for a single individual to accurately position the trailer hitch ball under the trailer connecting mechanism of a trailer. Generally, those experiences in hooking up a trailer can guide the vehicle toward the trailer in breadth, but find it very difficult to gage the distance that must be traversed toward the trailer. It would be a benefit, therefore, to have a device that allows the user to determine the how far to move the tow vehicle toward the trailer.

### SUMMARY OF THE INVENTION

The present invention relates to a vehicle positioning system and method for assisting a driver in positioning a vehicle relative to a trailer. In one embodiment, an apparatus comprises a collapsible U-shaped mechanism with an adjustable length mid-section connected to a first arm positionable perpendicular to the adjustable length mid-section and having a half-circular cross section and a second arm positionable perpendicular to the adjustable length mid-section and having a rectangular cross section; the adjustable length mid-section being used to gauge the distance between the trailer attachment end of the trailer and the trailer ball of the trailer hitch. The use of a half-circular cross section in the first arm and the use of a rectangular cross section in the second arm are for illustrative purposes only. What is required in that the first arm comprise a cross section that facilitates the ability of a vehicle wheel to run over the cross section. Also, it is desirable that the cross section of the second arm hinder the ability of a vehicle wheel from rolling over that second arm.

In use, the user adjusts the length of the adjustable length mid-section until the length of the adjustable length mid-section equals the distance between the trailer hitch ball and trailer attachment end. Once this is accomplished, the user ensures the first arm is in perpendicular orientation to the adjustable length midsection and positions the first arm against the back side of a tire of the vehicle on which the trailer hitch is mounted such that the axis of the adjustable length midsection is aimed directly toward the trailer attachment end of the trailer. After ensuring the second arm is in perpendicular orientation to the adjustable length mid-section, the user then moves the vehicle in the direction of the axis of the adjustable length mid-section until the user feels the back tire of the vehicle contact the second arm. This provides an indication that alignment between the trailer hitch ball and the trailer attachment portion has been achieved and, thereby, eliminating the constant repositioning of the vehicle when a single person is attempting to attach the trailer attachment mechanism of a trailer to a trailer ball of a trailer hitch.

In the method aspect of the invention, vehicle hitch positioning method includes the steps of a) supplying an embodiment of the self hitch vehicle positioning system such as described above; b) adjusting the length of the adjustable length mid-section until the length of the adjustable length mid-section equals the distance between the trailer hitch ball and trailer attachment end; c) the user then ensures the first arm is in perpendicular orientation to the adjustable length midsection and positions the first arm against the back side of the back tire of the vehicle on which the trailer hitch is mounted such that the axis of the adjustable length mid-section is aimed directly toward the trailer attachment end of the trailer; d) after ensuring the second arm is in perpendicular orientation to the adjustable length mid-section, the user then backs the vehicle in the direction of the axis of the adjustable length mid-section until the user feels the back tire of the vehicle contact the second arm which provides an indication that the exact alignment between the trailer hitch ball and the trailer attachment portion has been achieved.

### BRIEF DESCRIPTION OF THE DRAWINGS

The foregoing aspects are better understood from the following detailed description of one embodiment of the invention with reference to the drawings, in which:

FIG. 1 shows an exemplary embodiment of the self hitch vehicle positioning system of the present invention;

FIG. 2 shows a representative trailer attachment section of a trailer and a trailer hitch ball along with a representative vehicle tire; and

FIG. 3 shows the self hitch vehicle positioning system folded and positioned within a handy carrying bag.

### DETAILED DESCRIPTION OF THE INVENTION

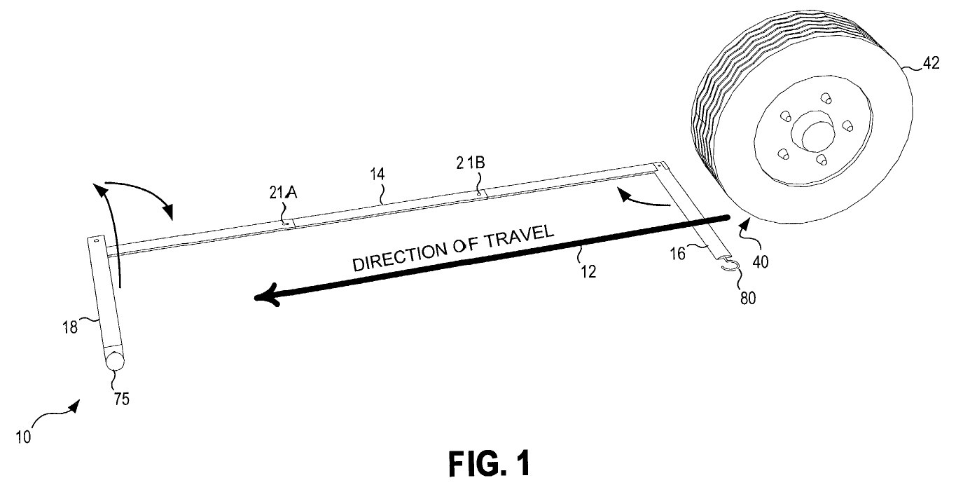

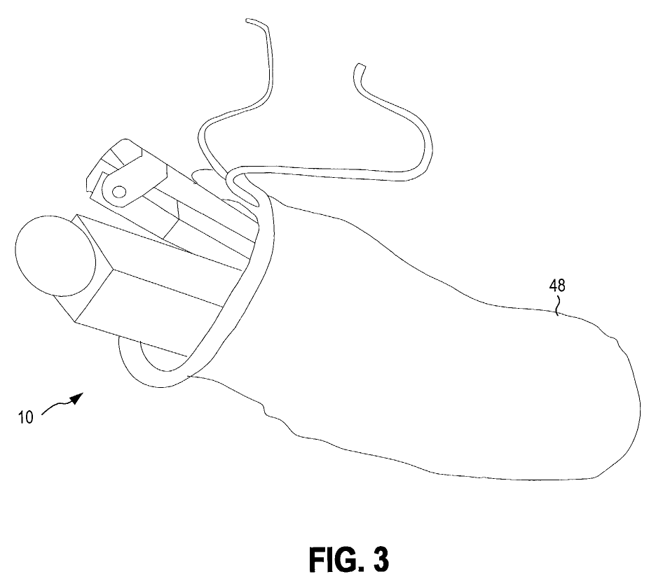

FIG. 1 through FIG. 3 show various aspects of an exemplary embodiment of the self hitch vehicle positioning system of the present invention generally designated 10. Self hitch vehicle positioning system 10 includes an interlocking collapsible U-shaped mechanism generally designated 12 having an adjustable length mid-section 14, a first fold out arm 16 comprising a semi-circular cross section and a second fold out arm 18 comprising a square cross section. First and second fold out arms 16,18 are foldable into a perpendicular position with respect to the adjustable length middle 14. This adjustable length middle is also referred to as a telescopic span assembly.

This telescopic span assembly comprises a plurality of sections, each section being progressively smaller that it's preceding section and having an orifice to accept a progressively smaller subsequent section. The telescopic span assembly may further comprise locking mechanisms that hold each section fast relative to the other sections in the span assembly. The telescopic span assembly may further comprise detent mechanisms that hold each section fast relative to the other sections in the span assembly so long as a force applied longitudinally to the span assembly does not overcome the detent force of the detent mechanisms.

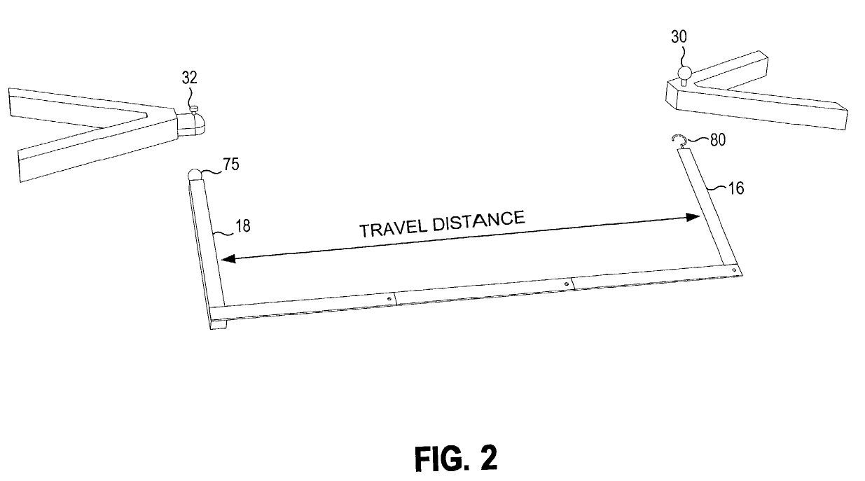

FIG. 2 shows that, in use, the user adjusts the length of telescopic span section 14 to correspond with the distance between the center of the trailer hitch attachment mechanism 32 and the trailer hitch ball 30 of a trailer hitch attached to a vehicle and locks mid-section 14 with locking mechanisms 21a,21b. To facilitate the length adjustment process, the first arm may further comprise a trailer hitch ball 75 that is used to mimic the positioning of an actual trailer hitch ball relative to the trailers hitch attachment mechanism. The second arm may further comprise a hook mechanism that can be used to center the second arm about the centerline of the actual trailer hitch ball mounted in the tow vehicle. The apparatus may further comprise a latching mechanism that holds the first arm perpendicular to the telescopic span assembly. The apparatus may also further comprise a latching mechanism that holds the second arm perpendicular to the telescopic span assembly. These latching mechanisms may comprise locking assemblies or a detent mechanism.

The user then ensures the first arm 16 is in perpendicular orientation to the adjustable length telescopic span section 14 and positions the first arm 16 against the back side 40 of the back tire 42 of the vehicle on which the trailer hitch ball 30 is mounted such that the axis of the adjustable length mid-section 14 is aimed directly toward the trailer attachment end 32 of the trailer.

After ensuring the second arm 18 is in perpendicular orientation to the adjustable length mid-section 14, the user then backs the vehicle in the direction of the axis of the adjustable length mid-section 14 until the user feels the back tire 42 of the vehicle contact the second arm 18 which provides an indication that the exact alignment between the trailer hitch ball 30 and the trailer attachment portion 32 has been achieved. It should be noted that use of the back tire is for illustrative purposes only and that the user can position the self hitch apparatus proximate to any wheel on the tow vehicle. Not withstanding this conventional application, the user may choose to move the trailer toward the tow vehicle. In this case, the self-hitch apparatus will be positioned in front of one of the wheels on the trailer. This particular application may be useful when the trailer is actually another vehicle that includes a tow bar for towing the second vehicle behind the first tow vehicle.

Once attachment of trailer hitch ball 30 and trailer attachment mechanism 32 has been accomplished, self hitch vehicle positioning system 10 can be collapsed for storage and stored in a provided storage bag 48.

What is claimed is:

1. A trailer hitching guide comprising:
telescopic span assembly having a first end and a second end;
first guide stop pivotally attached to said first end of the telescopic span assembly;
second guide stop pivotally attached to said second end of the telescopic span assembly.

2. The trailer-hitching guide of claim 1 wherein the telescopic span assembly comprises a section having a receiving port for receiving progressively smaller span section.

3. The trailer-hitching guide of claim I wherein the telescopic span assembly further comprises a latching mechanism that precludes the expansion or contraction of the telescopic span assembly.

4. The trailer-hitching guide of claim 1 wherein the telescopic span assembly further comprises a detent mechanism that resists the expansion or contraction of the telescopic span assembly, but will allow contraction or expansion of the telescopic span assembly if a force sufficient to overcome a detent stop is applied to the telescopic span assembly.

5. The trailer-hitching guide of claim 1 wherein the first guide stop further comprises a rectangular cross section.

6. The trailer-hitching guide of claim 1 wherein the second guide stop further comprises a semi-circular cross section.

7. The trailer-hitching guide of claim 1 wherein the first guide stop further comprises a wheel stop.

8. The trailer-hitching guide of claim 1 wherein the second guide stop further comprises a trailer hitch attachment ring.

9. The trailer-hitching guide of claim 1 further comprising a first right-angle stop that locks the first guide stop normal to the telescopic span assembly that may comprise a locking means or a detent means.

10. The trailer-hitching guide of claim 1 further comprising a second right-angle stop that locks the first guide stop normal to the telescopic span assembly that may comprise a locking means or a detent means.

11. A method for breaching the distance from a tow vehicle to a trailer comprising the steps of:
adjusting the length of a telescopic span apparatus to match the distance between a hitch mounted on a tow vehicle and a trailer-hitch mounted on a trailer;
setting the telescopic span apparatus immediately behind one wheel of the tow vehicle oriented in the direction of travel necessary to engage the trailer with the tow vehcile;
moving the tow vehicle toward the trailer until said wheel reaches the end of the telescopic span apparatus.

12. The method of claim 11 wherein the telescopic span apparatus comprises an adjustable length mid-section and a first arm and further comprising the step of articulating the first arm perpendicular to the adjustable length mid-section.
